(19) United States
(12) Patent Application Publication
(10) Pub. No.: US 2002/0163401 A1
(43) Pub. Date: Nov. 7, 2002

(54) Wideband coaxial orthogonal-mode junction coupler

(76) Inventor: Henry Z. Zhang, Bellevue, WA (US)

Correspondence Address: NIXON &VANDERHYE P.C., 8th Floor, 1100 North Glebe Rd., Arlington, VA, 22201-4714, US

(21) Appl. No.: 10/133,423

(22) Filed: Apr. 29, 2002

(30) Foreign Application Priority Data
May 1, 2001 (AU) PR4693

(51) Int. Cl. H01P 5/12

(52) U.S. Cl. 333/135; 333/254

(57) ABSTRACT

A wideband, coaxial orthogonal-mode junction or OMJ coupler (420) is disclosed. The OMJ coupler (420) includes a coaxial waveguide (420A) having two or more ridges (460), two or more sectoral waveguides (420B,462) having a corresponding number of ridges or T-septa (460) as the coaxial waveguide (420A), and a mechanism for converting (470) the coaxial waveguide (420A) into the sectoral waveguides (420B) formed inline with the coaxial and sectoral waveguides (420A,420B). The converting mechanism preferably includes at least two metal fins (470) symmetrically disposed in the coaxial waveguide (420A) and coupled to the sectoral waveguides (420B). Optionally, the metal fins (1270) are tapering in shape. More preferably, there are four metal fins (470, 1270), four sectoral waveguides (420B), and four ridges or T-septa (460) in the coaxial and sectoral waveguides (420A, 420B).

### FIELD OF THE INVENTION

The present invention relates generally to waveguides and associated couplers for transmitting high frequency signals and in particular to coaxial orthogonal-mode-junction (OMJ) couplers.

### BACKGROUND

Two structures have been proposed for separating dual-polarised bands propagating in a horn antenna.

The first structure is a quad-ridged circular coaxial waveguide diplexer: Zhang, H. Z., and James, G. L., “Characteristics of quad-ridged coaxial waveguides for dual-band horn applications”, IEE Proc.-Microw. Antennas Propag., Vol. 145, No. 3, June 1998; and Zhang, H. Z., “Cutoff and bandwidth characteristics of a circular coaxial waveguide with four T-Septa symmetrically placed in the inner conductor”, IEE Proc.-Microw. Antennas Propag., Vol. 145, No. 4, August 1998. In the quad-ridged waveguide diplexer, a lower band signal propagates in a coaxial quad-ridged region and a highest band propagates in the inner circular waveguide. A desired hybrid TE₁₁ mode in the coaxial region is excited by a probe in each of the ridges with minimum disturbance to the highest band propagating in the inner circular waveguide.

The second structure is a circular coaxial orthogonal-mode-junction coupler or simply a circular OMJ coupler: Zhang, H. Z., “Circular coaxial orthogonal-mode-junction coupler and its application”, IEE Proc.-Microw. Antennas Propag., Vol. 147, No. 1, February 2000. This coupler has a circular coaxial waveguide with four side-coupled rectangular waveguides and is used as multiband coupler. A lower band signal is extracted from the coaxial waveguide by means of the four rectangular waveguides and re-combined later using a circular OMJ, once the higher band signal has been extracted from the in-line feed system attached to the inner circular waveguide.

Both of these structures have a number of disadvantages. One is that the probe excitation in the quad-ridged coaxial waveguide is difficult to analyse and thereby optimise effectively. Furthermore, coupling between the probes can be a serious issue, especially for dual-polarisation operation. Moreover, this structure has found difficulty in extracting multiple bands, and current designs rely largely on empirical methods.

By contrast, the circular coaxial OMJ has been rigorously analysed with-multi-band signals extracted (diplexed) by a series of coaxial OMJs. However, the bandwidth of these coaxial OMJs is limited by the coaxial waveguide structure itself and the use of iris-matching to achieve acceptable performance. To date, the maximum achieved bandwidth is less than 10% for these structures, thereby limiting the full bandwidth potential of the feed-horns.

Thus, a need clearly exists for an improved OMJ coupler to overcome, or at least ameliorate, one or more of the disadvantages of the foregoing structures.

### SUMMARY

In accordance with a broad aspect of the invention, there is disclosed a wideband, coaxial orthogonal-mode junction or OMJ coupler. The OMJ coupler includes a coaxial waveguide having two or more ridges or T-septa, two or more sectoral waveguides having a corresponding number of ridges or T-septa as the coaxial waveguide, and a mechanism for converting the coaxial waveguide into the sectoral waveguides. The converting means is formed inline with the coaxial waveguide and the sectoral waveguides. Optionally, the coaxial waveguide may be circular or square.

Preferably, the converting means is integrally formed in the coaxial waveguide and the sectoral waveguides, and more preferably includes two or more metal fins symmetrically disposed around the coaxial waveguide and coupled to the sectoral waveguides. Optionally, the metal fins may be tapering in shape, extending from the coaxial waveguide toward the sectoral waveguides.

More preferably, the OMJ coupler has four metal fins and four sectoral waveguides. Optionally, the number of ridges or T-septa in the coaxial waveguide and the sectoral waveguides is four.

Optionally, the two or more ridges or T-septa of the coaxial waveguide and the sectoral waveguides are:

two or more ridges symmetrically placed around an inner conductor of the coaxial waveguide and corresponding ridges disposed in narrow walls of the sectoral waveguides; or

two or more ridges symmetrically placed around an outer conductor of the coaxial waveguide and corresponding ridges disposed in broad walls of the sectoral waveguides; or

two or more double-ridges symmetrically placed in the coaxial waveguide and corresponding double-ridges disposed in the sectoral waveguides; or

two or more T-septa symmetrically placed around an inner conductor of the coaxial waveguide and corresponding T-septa disposed in narrow walls of the sectoral waveguides; or

two or more T-septa symmetrically placed around an outer conductor of the coaxial waveguide and corresponding T-septa disposed in broad walls of the sectoral waveguides; or

two or more double-T-septa symmetrically placed in the coaxial waveguide and corresponding double-T-septa disposed in the sectoral waveguides. Preferably, the two or more ridges or T-septa of the coaxial waveguide are separated by a corresponding number of metal fins symmetrically disposed in the coaxial waveguide as the converting means to separate the ridges or T-septa one from another.

Preferably, a dual-polarised signal input via the coaxial waveguide is separated into the sectoral waveguides. The dual-polarised signal may be separated into a higher band signal transmitted by an inner waveguide of the coaxial waveguide and one or more lower band signals transmitted via the sectoral waveguides. A hybrid TE₁₁ mode in the coaxial waveguide can be transformed into a hybrid TE₁₀ mode in each of the sectoral waveguides. Optionally, the OMJ coupler includes two or more coaxial probes or rectangular waveguides using a T-junction type of structure, wherein the hybrid TE₁₀ mode signals in the sectoral waveguide are coupled to the coaxial probes or rectangular waveguides. Still further, the OMJ coupler may include a coaxial power combiner or a circular orthogonal-mode junction to recombine opposite pairs of the hybrid TE₁₀ mode signals in the coaxial cables or rectangular waveguides to extract the hybrid TE₁₀ mode signals. Optionally, the OMJ coupler includes:

a series of coaxial probes in the sectoral waveguides for extracting the hybrid TE₁₀ mode signals and a coaxial power combiner for recombining the extracted hybrid TE₁₀ mode signals; or

a series of rectangular waveguides on a broad wall of the sectoral waveguides for extracting the hybrid TE₁₀ mode signals and a coaxial power combiner or circular orthogonal-mode junction for recombining the extracted hybrid TE₁₀ mode signals. Optionally, the rectangular waveguides may be ridged or have T-septa.

Optionally, the OMJ coupler has a dual-ridged or dual-T-septum coaxial structure and two sectoral ridged or T-septum waveguides for transforming a single-polarized signal from a coaxial horn into sectoral waveguides. Also optionally, tapering metal fins may be used to separate a quad-ridged or quad-T-septum coaxial waveguide into ridged or T-septum sectoral waveguides for reducing reflection.

### BRIEF DESCRIPTION OF THE DRAWINGS

A number of embodiments of the invention are described hereinafter, by way of example only, with reference to the accompanying drawings in which:

FIGS. 1A and 1B are side elevational and rear, cross-sectional views of a wideband coaxial orthogonal-mode junction (OMJ) coupler in accordance with a first embodiment of the invention connecting with a dielectric-cone-loaded horn; FIGS. 2A and 2B are side elevational and rear, cross-sectional views of the wideband coaxial OMJ coupler in accordance with the first embodiment of the invention connecting with a coaxial horn; FIGS. 3A and B are side elevational and rear, cross-sectional views of the wideband coaxial OMJ coupler in accordance with the first embodiment of the invention connecting with a circular horn;

FIGS. 4A, 4B, and 4C are front cross-sectional, side elevational, and rear cross-sectional views of the wideband coaxial OMJ coupler using a junction of circular coaxial waveguide with four ridges symmetrically placed around an inner conductor and four single-ridged sectoral waveguides of FIGS. 1 to 3;

FIGS. 5A, 5B and 5C are front cross-sectional, side elevational, and rear cross-sectional views of a wideband coaxial OMJ coupler using a junction of circular coaxial waveguide with four ridges symmetrically placed around an outer conductor and four single-ridged sectoral waveguides in accordance with a second embodiment of the invention;

FIGS. 6A, 6B, and 6C are front cross-sectional, side elevational, and rear cross-sectional views of a wideband coaxial OMJ coupler using a junction of circular coaxial waveguide with four symmetrically placed double ridges and four double-ridged sectoral waveguides in accordance with a third embodiment of the invention;

FIGS. 7A, 7B, and 7C are front cross-sectional, side elevational, and rear cross-sectional views of a wideband coaxial OMJ coupler using a junction of circular coaxial waveguide with four T-septa symmetrically placed around an inner conductor and four single-T-septum sectoral waveguides in accordance with a fourth embodiment of the invention;

FIGS. 8A, 8B, and SC are front cross-sectional, side elevational, and rear cross-sectional views of a wideband coaxial OMJ coupler using a junction of circular coaxial waveguide with four T-septa symmetrically placed in outer conductor and four single-T-septum sectoral waveguides in accordance with a fifth embodiment of the invention;

FIGS. 9A, 9B, and 9C are front cross-sectional, side elevational, and rear cross-sectional views of a wideband coaxial OMJ coupler using a junction of circular coaxial waveguide with four symmetrically placed double T-septa and four double-T-septum sectoral waveguides in accordance with a sixth embodiment of the invention;

FIGS. 10A, 10B, and 10C are front cross-sectional, side elevational, and rear cross-sectional views of a wideband coaxial OMJ coupler using a junction of a square coaxial waveguide with four symmetrically placed double-ridges and four double-ridged sectoral waveguides in accordance with a seventh embodiment of the invention;

FIGS. 11A, 11B, and 11C are front cross-sectional, side elevational, and rear cross-sectional views of a wideband coaxial OMJ coupler using a junction of a square coaxial waveguide with four symmetrically placed double-T-septa and four double-T-septum sectoral waveguides in accordance with an eighth embodiment of the invention;

FIGS. 12A, 12B, and 12C are front cross-sectional, side elevational, and rear cross-sectional views of a wideband coaxial OMJ coupler using tapering metal fins to separate the quad-ridged coaxial waveguide into four ridged sectoral waveguides in accordance with a ninth embodiment of the invention;

FIGS. 13A and 13B are side elevational and rear cross-sectional views illustrating an excitation method using coaxial probes for a wideband coaxial OMJ coupler in accordance with the embodiments of the invention;

FIGS. 14A and 14B are side elevational and rear cross-sectional views illustrating an excitation method using rectangular waveguides for a wideband coaxial OMJ coupler in accordance with the embodiments of the invention;

FIG. 15 is a side elevational view illustrating an excitation method using four rectangular waveguides and a circular OMJ for a wideband coaxial OMJ coupler in accordance with the embodiments of the invention;

FIGS. 16A and 16B are side elevational and rear cross-sectional views illustrating an excitation method using four ridged rectangular waveguides for a wideband coaxial OMJ coupler in accordance with the embodiments of the invention;

FIG. 17 is a side elevational view illustrating a multi-band excitation method using coaxial probes and coaxial power combiners for a wideband coaxial OMJ coupler in accordance with the embodiments of the invention;

FIG. 18 is a side elevational view illustrating a multi-band excitation method using rectangular waveguides and circular OMJs for a wideband coaxial OMJ coupler in accordance with the embodiments of the invention;

FIG. 19 is a side elevational view illustrating a multi-band excitation method using rectangular waveguides and coaxial power combiners for a wideband coaxial OMJ coupler in accordance with the embodiments of the invention;

FIGS. 20A, 20B. 20C and 20D are side elevational, front cross-sectional, A-A cross-sectional, and rear cross-sectional views of a wideband coaxial OMJ coupler involving the transformation of sectoral ridged waveguide to standard rectangular single-ridged waveguide in accordance with a tenth embodiment of the invention;

FIGS. 21A, 21B, and 21C are front cross-sectional, side elevational, and rear cross-sectional views of a wideband coaxial OMJ coupler using four metal fins to separate a dual-ridged coaxial waveguide into two single-ridged sectoral waveguides for single-polarized applications in accordance with a eleventh embodiment of the invention;

FIGS. 22A, 22B, and 22C are front cross-sectional, side elevational, and rear cross-sectional views of a wideband coaxial OMJ coupler using four metal fins to separate a coaxial waveguide with two symmetrically placed T-septa into two single-T-septum sectoral waveguides for single-polarized applications in accordance with a twelfth embodiment of the invention;

FIGS. 23A, 23B, and 23C are front cross-sectional, side elevational, and rear cross-sectional views illustrating the dimensions of the junction of the quad-ridged waveguide and the four single-ridged waveguides for the wideband coaxial OMJ coupler shown in FIGS. 4A, 4B, and 4C; and

FIG. 24 is a chart illustrating the reflection coefficient of the junction of the quad-ridged coaxial waveguide and four single-ridged sectoral waveguides, as shown in FIGS. 4 and 23, with the height of the ridge (p) as a parameter.

### DETAILED DESCRIPTION

Wideband coaxial orthogonal-mode junction (OMJ) couplers are described. In the following description, numerous details are set forth including particular numbers of ridges, T-septa, metal fins, and sectoral waveguides. It will be apparent to one skilled in the art, however, that the present invention may be practised without these specific details. In other instances, well-known features are not described in detail so as not to obscure the present invention. Also, in the drawings, elements in one drawing with like corresponding elements in another drawing are indicated with the convention that the last two digits are the same. For example, element XX01 in FIG. X corresponds to element YY01 in FIG. Y. For purposes of brevity only, the description of elements such as YY01 may not be repeated. Further, the embodiments described hereinafter may be practiced with ridges and T-septa being used interchangeably.

The wideband coaxial OMJ couplers according to the embodiments of the invention have been developed primarily for separating multiple bands from a circular, coaxial or dielectric-cone-loaded feed-horn and are described hereinafter with reference to that application. Such horn antennas may be used in the 0.2-300 GHz spectrum, for example. However, it will be apparent to those skilled in the art from this disclosure that the invention is not limited to this particular field of use. For example, the wideband coaxial OMJ coupler according to the embodiments of the invention is also suitable for separating any bands from any type of waveguide structures in antenna applications, and any other electromagnetic applications.

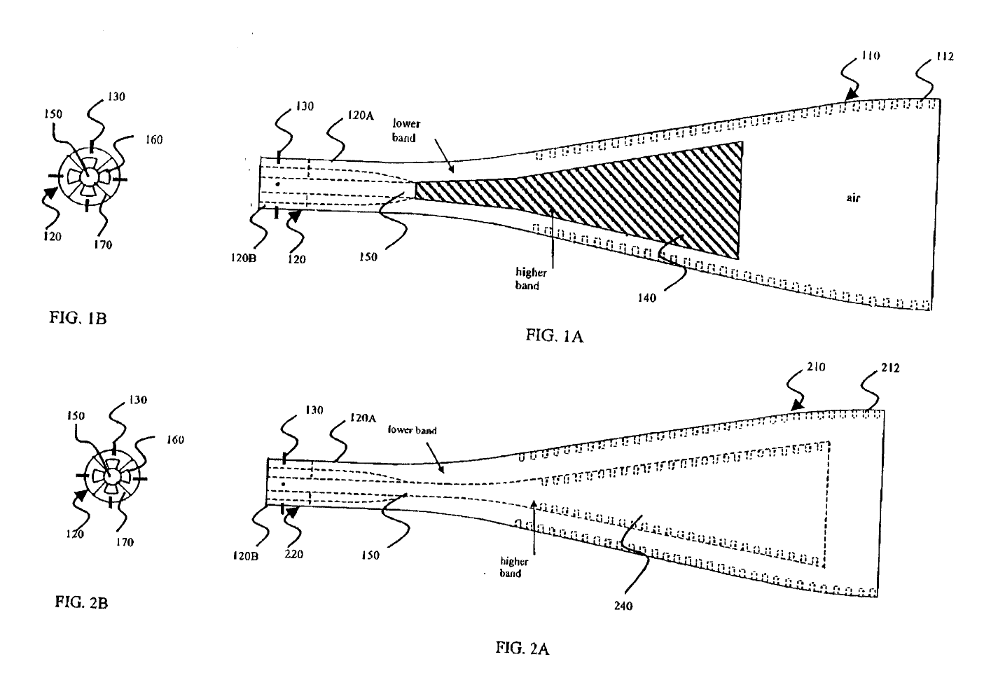

FIGS. 1A and 1B show a wideband orthogonal-mode junction coupler 120 in accordance with a first embodiment of the invention connected to a horn antenna 110. The horn antenna 110 has a concentric dielectric cone 140 (indicated by diagonal lines) disposed therein. The remainder of the internal cavity of the antenna 110 is air. Irises 112 are located within the interior surface of the horn antenna 110 preferably and are indicated by dashed lines.

In the horn antenna 110, higher band signals are conducted via the dielectric cone 140 and lower band signals are conducted by the surrounding air media. Dual-polarised dual-band signals can be coupled from the dielectric-cone-loaded or coaxial horn 110 to a quad-ridged circular coaxial waveguide 120A via the wideband coaxial OMJ coupler 120. As shown in FIG. 1B, preferably four ridges 160 are disposed symmetrically the inner circular waveguide 150. The higher band is coupled to the inner circular waveguide 150 that makes up the core of the coaxial waveguide 120. The lower band is coupled to the quad-ridged coaxial region. The quad-ridged circular coaxial waveguide 120A is converted to four single-ridged sectoral waveguides 120B by insertion of four metal fins 170.

Dual-polarised signals in the quad-ridged coaxial waveguide 120A then separate into the four single-ridged sectoral waveguides 120B. The hybrid TE₁₁ mode in the quad-ridged region is transformed to a hybrid TE₁₀ mode in each of the sectoral waveguides 120B. The hybrid TE₁₀ mode signals in opposite pairs of these sectoral ridged waveguides 120B can be extracted by excitation probes 130 and recombined in various ways, described hereinafter.

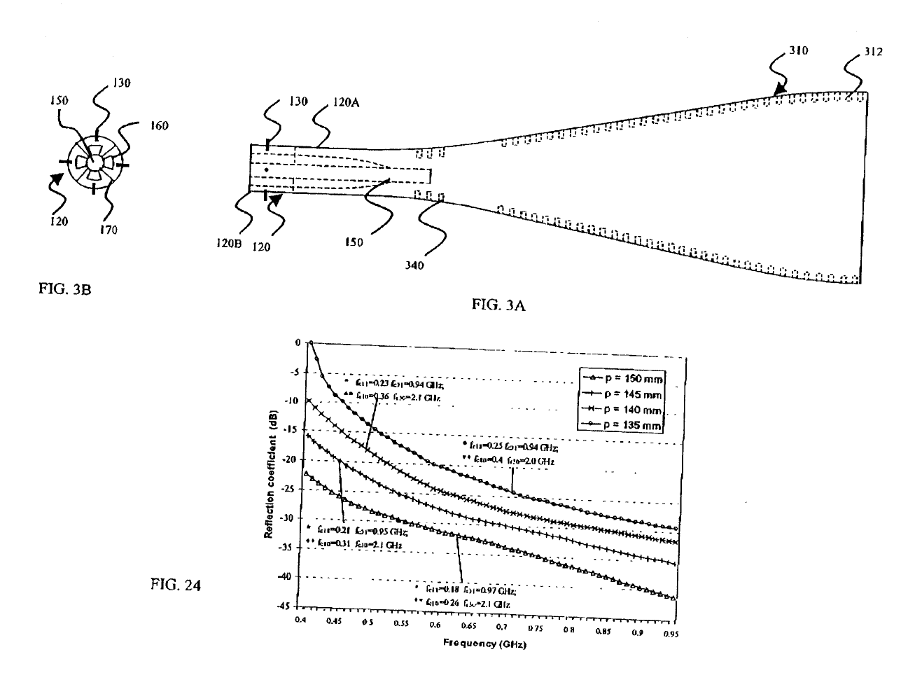

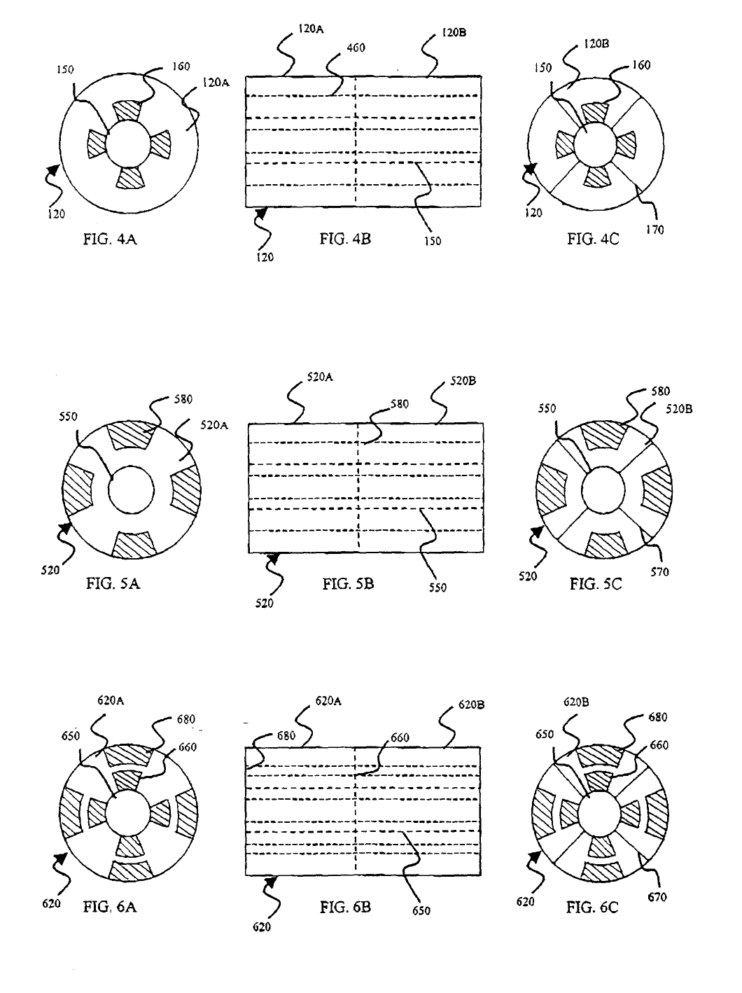

The details of the wideband coaxial OMJ coupler 120 are shown in FIG. 4. In particular, FIG. 4A shows a front cross-sectional view of the circular coaxial waveguide 120A, as viewed from the connection with the horn antenna 110, 210, and 310. FIG. 4C shows a rear cross-section view of the sectoral waveguides 120B.

FIGS. 2A and 2B illustrate a similar configuration as that shown in FIGS. 1A and 1B, except that the dielectric-cone-loaded horn 110 is replaced with a coaxial horn 210. This antenna 210 has an internal, concentric horn antenna 240 that is directly coupled to the inner coaxial wave guide 250. The remainder of the configuration is the same as that for FIG. 1 and the same reference numerals are used.

FIGS. 3A and 3B illustrate yet another similar configuration as those shown in FIGS. 1 and 2, except that the horn antennas 110 and 210 are replaced by a circular horn antenna 310. For the circular horn 310, the incoming waves are coupled to the coaxial waveguide 320A by using few matching irises, as shown in FIG. 3. The wideband coaxial OMJ couplers according to the other embodiments of the invention described hereinafter can equally be practiced with the horn antennas shown in FIGS. 1 to 3 in place of the wideband coaxial OMJ coupler of the first embodiment.

FIGS. 5A, 5B and 5C illustrate a wideband coaxial OMJ coupler 520 in accordance with a second embodiment of the invention having a junction of circular coaxial waveguide 520A with four ridges 580 symmetrically placed around the outer conductor (rather than the inner conductor formed by central waveguide 550) and four single-ridged sectoral waveguides 520B to convert the hybrid TE₁₁ mode in coaxial waveguide 520A to hybrid TE₁₀ mode. Again, metal fins 570 are used to form the sectoral waveguides 520B.

FIGS. 6A, 6B, and 6C illustrate a wideband coaxial OMJ coupler 620 in accordance with a third embodiment of the invention having a junction of circular coaxial waveguide 620A with four symmetrically placed double-ridges 660, 680 and four double-ridged sectoral waveguides 620B. T-septum waveguide can be used for the same purpose. The inner ridge 660 of each pair is smaller than the outer ridge 690, but otherwise the two are symmetrically aligned.

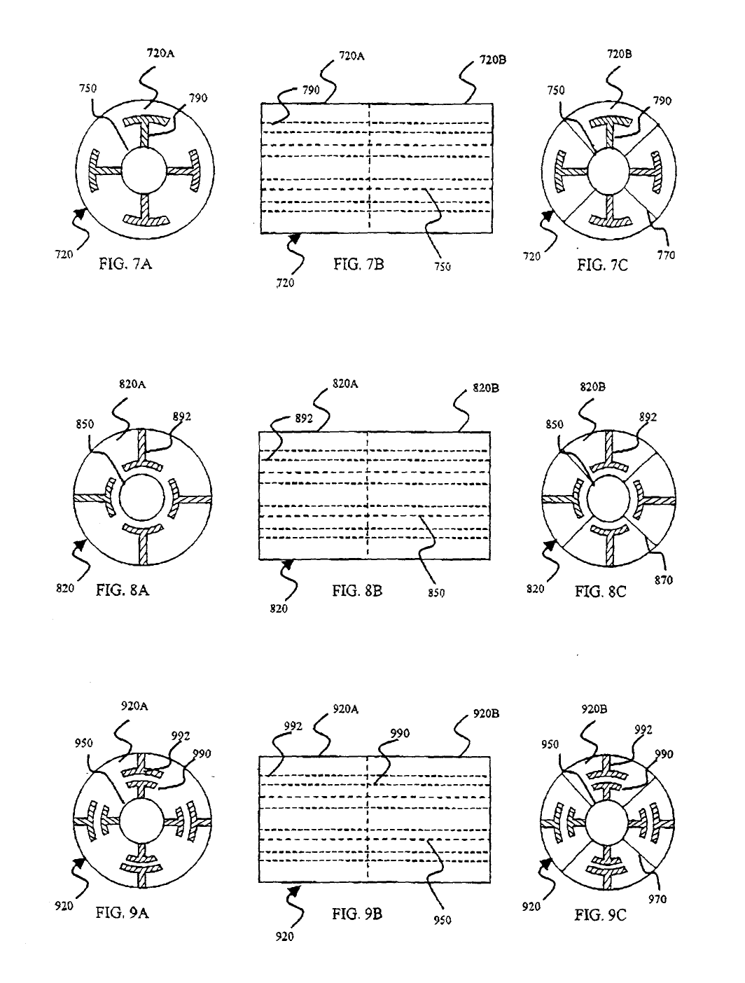

FIGS. 7A, 7B, and 7C illustrate a wideband coaxial OMJ coupler 720 in accordance with a fourth embodiment of the invention having a junction of a circular coaxial waveguide 720A with four T-septa 790 symmetrically placed around the inner conductor (formed by the central waveguide 750) and four single-T-septum sectoral waveguides 720B formed by metal fins 770 extending between the inner and outer conductors and lengthwise along the OMJ coupler 720.

FIGS. 8A, 8B, and 8C illustrate a wideband coaxial OMJ coupler 820 in accordance with a fifth embodiment of the invention having a junction of a circular coaxial waveguide 820A with four T-septa 892 symmetrically placed in the outer conductor and four single-T-septum sectoral waveguides 820B.

FIGS. 9A, 9B, and 9C illustrate a wideband coaxial OMJ coupler 920 in accordance with a sixth embodiment of the invention having a junction of a circular coaxial waveguide 920A with four symmetrically placed double T-septa 990, 992 and four double-T-septum sectoral waveguides 920B.

The conversion can also be made using square coaxial waveguides.

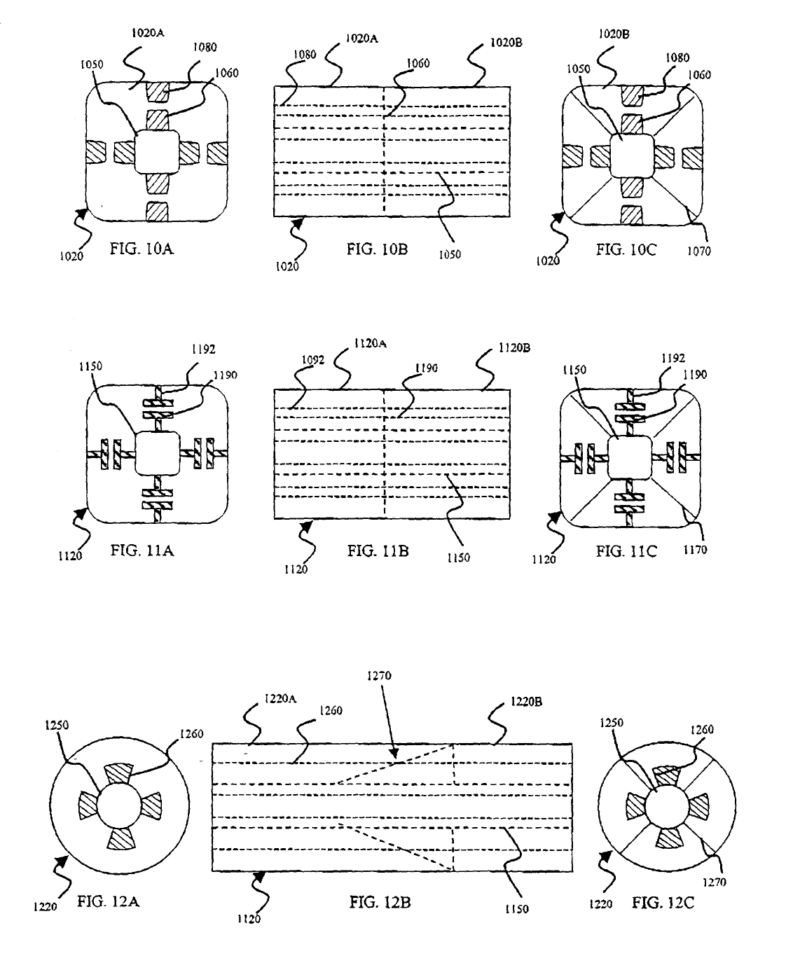

FIGS. 10A, 10B, and 10C illustrate a wideband coaxial OMJ coupler 1020 in accordance with a seventh embodiment of the invention having a junction of a square coaxial waveguide 1020A with four symmetrically placed double-ridges 1060, 1080 and four double-ridged sectoral waveguides 1020B. While ridge pairs are shown in FIG. 10, ridges on either the inner or outer conductor can be practiced in accordance with the principles of FIGS. 4 and 5.

FIGS. 11A, 11B, and 11C illustrate a wideband coaxial OMJ coupler 1120 in accordance with an eighth embodiment of the invention having a junction of a square coaxial waveguide 1120A with four symmetrically placed double-T-septa 1190, 1192 and four double-T-septum sectoral waveguides 1120B (formed by metal fins 1170). While double T-septa pairs are shown in FIG. 11, T-septa on either the inner or outer conductor can be practiced in accordance with the principles of FIGS. 7 and 8.

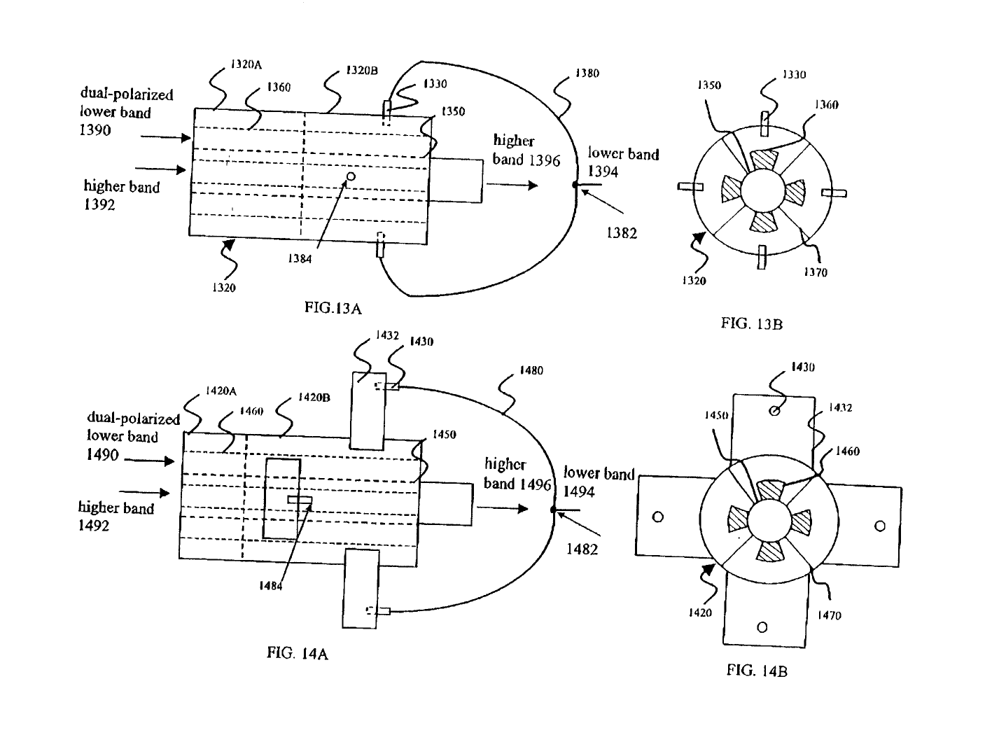

The separation of quad-ridged or quad-T-septum coaxial waveguide into four ridged or T-septum sectoral waveguides can also achieved by using tapering metal fins 1270, as shown in FIGS. 12A, 12B, and 12C. The tapering metal fin 1270 may reduce the reflection. Consequently, the bandwidth of the wideband OMJ may be improved further. While the tapered fin 1270 is shown in relation to the quad ridges of FIG. 4, the tapered fins may be practiced with any of the embodiments described hereinbefore and after. For example, tapering T-septa may be used.

The main advantage of the transformation of hybrid TE₁₁ mode in the quad-ridged or T-septum coaxial waveguide to hybrid TE₁₀ mode in four identical single-ridged or T-septum sectoral waveguides is simplification of analysis and design procedures. The advantage also includes enhanced isolation between orthogonal modes in the coaxial waveguide region as there is no direct cross-coupling among the sources.

FIGS. 13A and 13B show the application of an excitation method using coaxial probes 1330 for a wideband coaxial OMJ coupler 1320 in accordance with the embodiments of the invention. FIG. 13 shows the case of quad-ridged coaxial waveguide 1320A and single-ridged coaxial waveguides 1320B, for illustrative purposes only. Any of the other OMJ couplers in accordance with the embodiments of the invention may be practiced without departing from the scope and spirit of the invention. Similar comments apply to the other excitation methods and arrangements disclosed hereinafter. A dual polarized lower band 1390 and a higher band signal 1392 are input to the outer portion of the coaxial waveguide 1320A and the inner waveguide 1350, respectively. The TE₁₀ mode in each of these sectoral waveguides 1320B can be extracted using four coaxial probes 1330 and then recombined to polarized TE₁₁ mode using two coaxial power combiners 1382 (only one combiner is illustrated in FIG. 13A). The higher band 1396 is provided by the inner waveguide 1350 and the lower band 1394 is provided at the output of the combiners 1382. Probe 1384 is connected to the power splitter as an orthogonal band. Probes 1330 and 1384 are the same type of probes. Probe 1384 can be inline with 1330 and make no difference to the operation of the coupler. Power splitter is a device splitting the incoming signal from one port into two ports with equal power level.

FIGS. 14A and 14B show the application of another excitation method using four rectangular waveguides 1432 with coaxial probes 1430 for a wideband coaxial OMJ coupler 1420 in accordance with the embodiments of the invention. Again, a dual polarized lower band 1490 and a higher band signal 1492 are input to the outer portion of the coaxial waveguide 1420A and the inner waveguide 1450, respectively. The excitation of the desired TE₁₀ mode can be achieved using the four rectangular waveguides 1432 and recombined using four coaxial probes 1430 and two power combiners 1482. Again, the higher band 1496 is provided by the inner waveguide 1450 and the lower band 1494 is provided at the output of the combiners 1482. Probes 1484 and 1430 are again the same type of probes. Further, probe 1484 is connected to the power splitter as an orthogonal band.

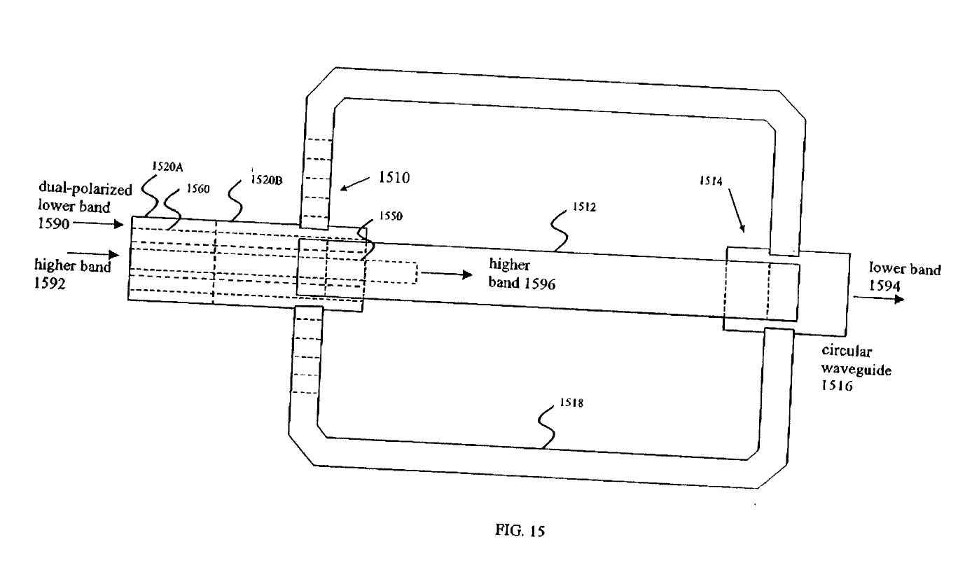

FIG. 15 shows the application of yet another excitation method for a wideband coaxial OMJ coupler 1520 in accordance with the embodiments of the invention and a conventional circular OMJ coupler 1514. Again, the wideband coaxial OMJ 1520 has a quad-ridged coaxial waveguide 1520A and sectoral ridged waveguides 1520B per FIG. 4, for illustrative purposes only. The dual polarized lower band 1590 and the higher band signal 1592 are input to the outer portion of the coaxial waveguide 1520A and the inner waveguide 1550, respectively. A polarized TE₁₁ mode signal is recombined using the conventional circular orthogonal-mode junction coupler 1514. The higher band signal 1596 goes through the inner waveguide 1550. The extraction of the lower band is achieved using rectangular waveguides 1512 and 1518 coupled to the sectoral ridged waveguide 1520B, which then pass through H-plane iris filters 1510 (indicated by dashed lines in 1510). The extracted signals are provided by rectangular waveguides 1512 and 1518 to the conventional circular OMJ 1514 coupled to circular waveguide 1516 to provide lower band 1594.

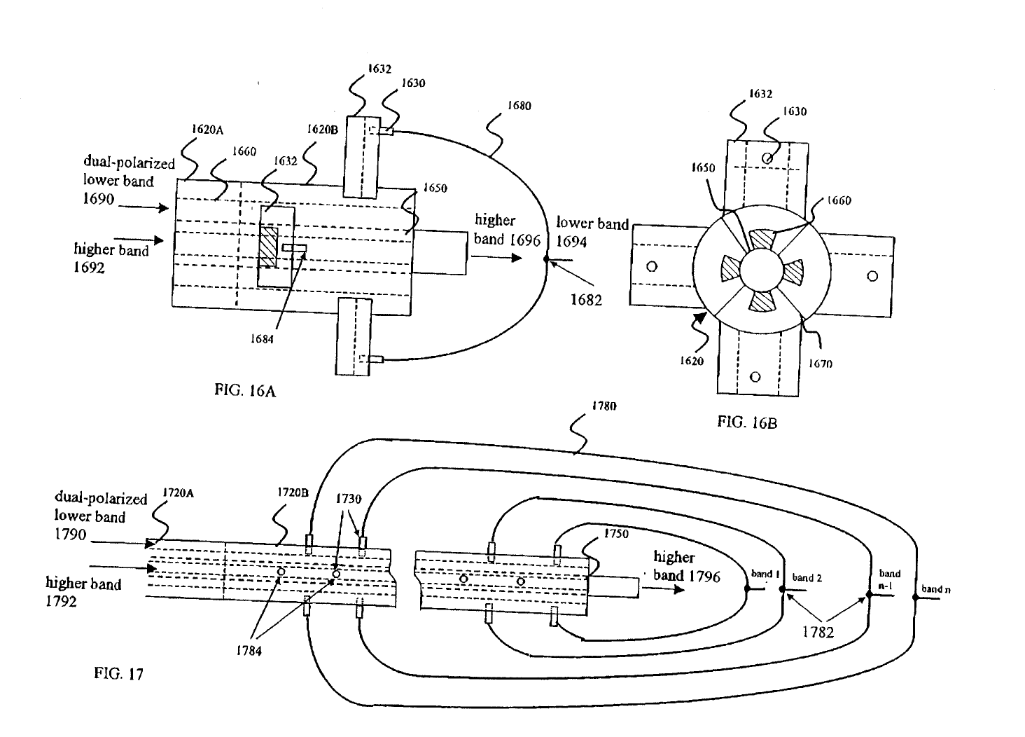

In yet another variation of the excitation method shown in FIGS. 14A and 14B, FIGS. 16A and 16B show a method using ridged rectangular waveguides 1632 in place of the rectangular waveguides 1432 of FIG. 14. The ridged rectangular waveguide are used for exciting the desired TE₁₀ mode in the sectoral waveguide. For brevity, like elements in FIGS. 14 and 16 have corresponding reference numbers and the relevant description is not repeated.

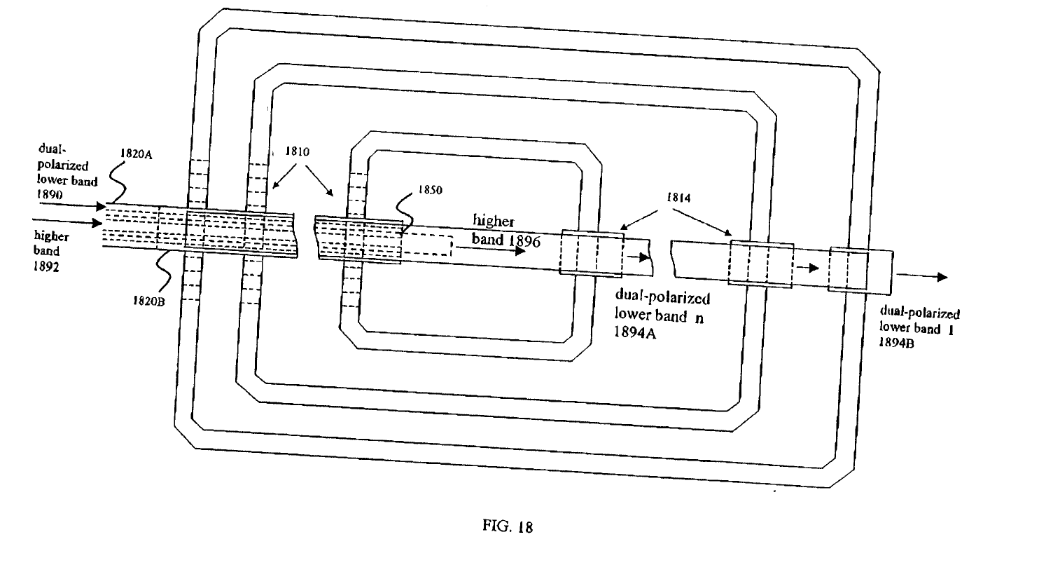

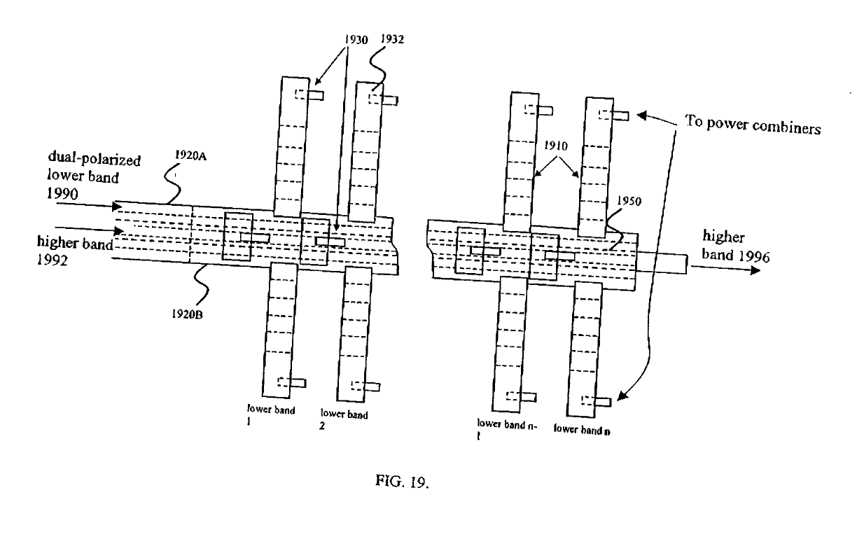

FIGS. 17, 18, and 19 show multiband diplexing achieved by employing a series of multiple coaxial probes, multiple rectangular waveguides, and multiple combinations of probes and rectangular waveguides in accordance with the teachings regarding the methods shown in FIGS. 13, 15, and 14, respectively, with appropriate adaptation for multiple rather than singular probes, waveguides, or combinations. As shown in FIG. 17, a higher band 1796 is provided by inner waveguide 1750 and n lower bands (band 1, . . . , band n) are produced by power combiners 1782. Similarly in FIG. 18, a higher band 1896 is provided by inner waveguide 1850 and n dual-polarized, lower bands (band 1894A, . . . , band 1894B corresponding to bands n and 1, respectively) are produced by power combiners conventional circular OMJ couplers 1814. As shown in FIG. 19, a higher band 1996 is provided by inner waveguide 1950 and n lower bands (band 1, . . . , band n) are extracted by rectangular waveguides 1932 and coaxial probes 1930 coupled to power combiners (not shown) produced by power combiners 1782. Each of the rectangular waveguides 1932 may have iris filters.

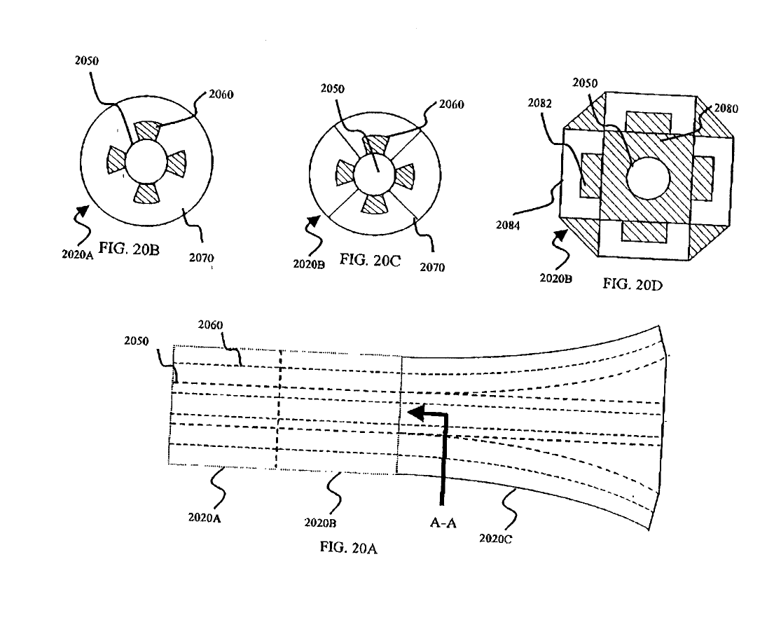

To simplify the design further, the single-ridged sectoral waveguide can be transformed to a standard single-ridged rectangular waveguide using a quarter-wave transformer or a slowly tapered section 2020C, as shown in FIGS. 20A-20C. FIG. 20A shows the coaxial OMJ coupler 2020 with coaxial waveguide portion 2020A, sectoral waveguide portion 202B, and tapering waveguide section 2020C with rectangular waveguides that flare away from the inner waveguide. FIG. 20B shows a circular coaxial waveguide 2020A per FIG. 4 with an inner waveguide 2050 and quad ridges 2060. FIG. 20C shows the sectoral waveguides 2062 viewed along the section A-A formed using metal fins 2070 with single ridges 2060 in each sectoral waveguide 2062. FIG. 20D shows the circular inner waveguide 2050 surrounded by four rectangular waveguides 2020C after the transformation. Each rectangular waveguide 2084 has a rectangular ridge 2082. Following this transformation, off-the-shelf components can then be used directly for launching the required hybrid TE₁₀ mode.

Coaxial quad-ridged and quad-T-septum waveguide and sectoral ridged and T-septum waveguide are well known as wide bandwidth structures. The wideband coaxial Orthogonal-Mode Junction coupler in accordance with the embodiments of the invention is a transformer that couples these two types of waveguides. The bandwidth of the coaxial OMJ coupler is determined by the reflection/transmission parameters of the junction. Usually the structure needs to be operated in the fundamental mode only and, therefore, the bandwidth is determined by the common bandwidth of the quad-ridged and single ridged waveguides.

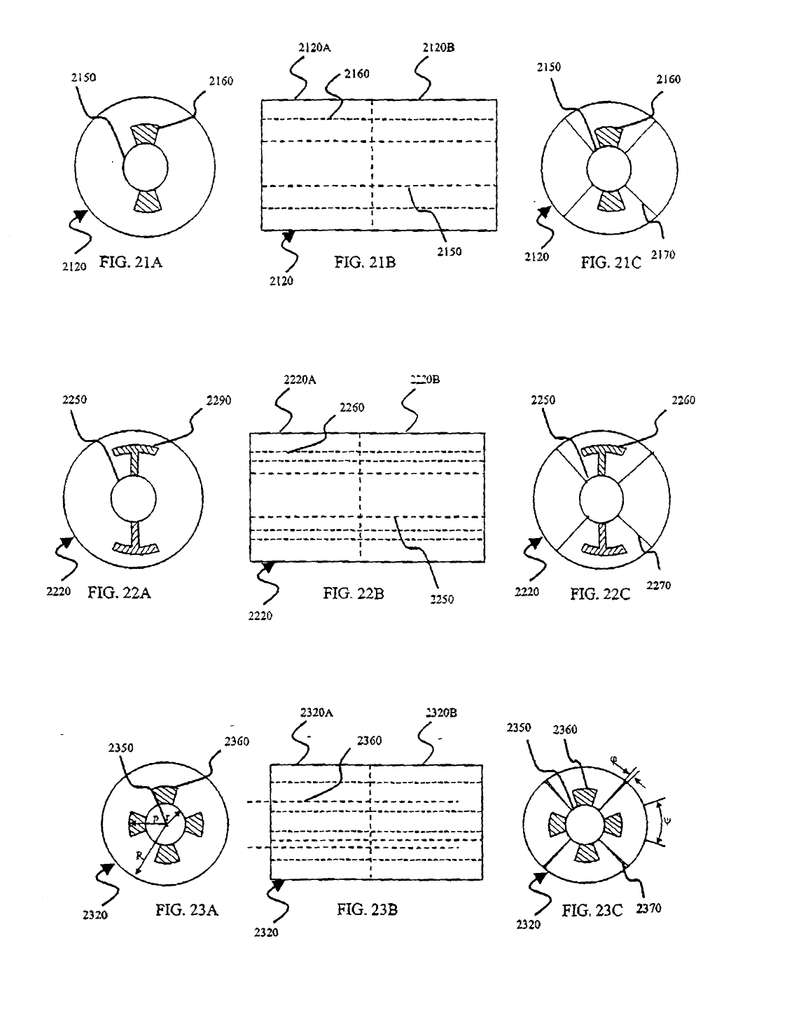

In some applications, only single polarisation may needed. Other variations to the embodiments described hereinbefore can be made without departing from the scope and spirit of the invention. A junction of dual-ridged or dual-T-septum coaxial and two ridged or T-septum sectoral waveguides is preferred for these applications. FIGS. 21A, 21B, and 21C show a wideband coaxial OMJ coupler 2120 using four metal fins 2170 to separate a dual-ridged coaxial waveguide 2120A into two single-ridged sectoral waveguides 2120B for single-polarized applications in accordance with the eleventh embodiment of the invention.

FIGS. 22A, 22B, and 22C show a wideband coaxial OMJ coupler 2220 having four metal fins 2270 to separate a coaxial waveguide 2220A with two symmetrically placed T-septa 2290 into two single-T-septum sectoral waveguides 2220B for single-polarized applications in accordance with the twelfth embodiment of the invention.

A preliminary study on the reflection coefficients of the junction has been conducted using the finite-element method. For simplification in the mathematical modelling, a sectoral metal fin as shown in FIG. 23 is used to separate the quad-ridged waveguides. In particular, FIGS. 23A, 23B, and 23C illustrate the dimensions of the junction of the quad-ridged waveguide 2320A and the four single-ridged waveguides 2320B for the wideband coaxial OMJ 2320. The relevant parameters are p, r, R, φ, and ψ which are described with reference to FIG. 24. r=60.8 mm, R=160 mm, φ=2°, and ψ=45°.

FIG. 24 shows the reflection coefficient (dB) in the quad-ridged coaxial waveguide end 2320A as a function of frequency with the height of the ridges (p) as a parameter (i.e., p=135 mm, 140 mm, 145 mm, and 150 mm). To evaluate the bandwidth, the cutoff frequencies for the given quad-ridged coaxial waveguide 2320A (TE₁₁ and TE₃₁; indicated with an “*”) and single-ridged sectoral waveguide 2320B (TE₁₀ and TE₃₀; indicated with “**”) are also given in the same figure. These cutoff frequencies have been verified using the mode-matching method.

FIG. 24 shows that the reflection coefficient reduces with increasing frequency. The figure also indicates that the reflection coefficient reduces with an increase in the height of the ridges. This is because the field intensity in the metal fin region decreases with the increase in height of the ridges; the reflection created by the wall (metal fin) of the sectoral waveguide reduces with increase in the height of the ridges. If a 20 dB return loss is regarded as the minimum performance and each structure is required to operate in the fundamental mode, FIG. 24 shows that the structure retains more than 40% of the bandwidth offered by the coaxial quad-ridged waveguide 2320A. For example, the bandwidth of the structure with ridge height p=150 mm has a bandwidth greater than 1:2.5 (retaining 45% of 1:5.5 bandwidth offered by the quad-ridged waveguide 2320B). As the bandwidth of the ridged coaxial and sectoral waveguides 2320A, 2320B increases with the height of the ridges, the bandwidth of the coaxial OMJ 2320A in accordance with the embodiments of the invention can be broadened by increasing the height of the ridges.

The junction between a quad-ridged or quad-T-septum coaxial waveguide and four ridged or T-septum sectoral waveguides in accordance with embodiments of the invention is disclosed as the basis of a broadband Orthogonal-Mode Junction Coupler. Analysis shows that the bandwidth of this structure is broad and can be obtained without complicated analysis and optimisation. The transformation from a dual-polarised quad-ridged or quad-T-septum coaxial waveguide to four identical ridged or T-septum sectoral waveguides significantly reduces the complexity of mathematical modelling. As a result, the wideband coaxial OMJ coupler in accordance with embodiments of the invention can be designed using rigorous methods and, with the separation among the launchers, the isolation between polarizations is greatly enhanced. The structure in accordance with embodiments of the invention provides increased flexibility for an antenna designer to configure the coaxial OMJ for single and multi-band applications. In addition, the ridged sectoral waveguide can be readily transformed to a standard ridged rectangular waveguide if desired and thereby utilise standard off-the-shelf components.

From the foregoing, it will be apparent to those skilled in the art that the wideband coaxial OMJ couplers in accordance with the embodiments of the invention have a number of advantages. These advantages include conversion from the TE₁₁ to TE₁₀ modes, which has low loss for sectoral waveguide. Further the waveguide structure is simplified, since the sectoral waveguide structure is simpler, one port converts to four ports. Still further the wideband coaxial OMJ couplers enable direct transfer to standard rectangular ridge waveguide using the sectoral waveguide. Yet another advantage is that mathematical modelling is not complicated as a consequence of separating into four segments. Still a further advantage is that extracting multiband signals is simplified and made easier. The optional tapered fins also improves matching with waveguide by reducing mismatch from the coaxial waveguide to the sectoral waveguide. A further advantage is that the wideband coaxial OMJ couplers enable wider bandwidths in certain antenna applications, especially horn antennas.

In the foregoing manner, a number of wideband coaxial orthogonal-mode junction couplers are disclosed. While a small number of embodiments are described, it will be apparent to those skilled in the art in view of this disclosure that numerous changes and/or modifications can be made without departing from the scope and spirit of the invention.

The claims defining the invention are as follows:

1. A wideband, coaxial orthogonal-mode-junction coupler, including:
a coaxial waveguide having two or more ridges;
two or more sectoral waveguides having a corresponding number of ridges or T-septa as said coaxial waveguide; and
means for converting said coaxial waveguide into said sectoral waveguides, wherein said converting means is formed inline with said coaxial waveguide and said sectoral waveguides.

2. The orthogonal-mode junction coupler according to claim 1, wherein said coaxial waveguide is circular.

3. The orthogonal-mode junction coupler according to claim 1, wherein said coaxial waveguide is square.

4. The orthogonal-mode junction coupler according to claim 1, wherein said converting means is integrally formed in said coaxial waveguide and said sectoral waveguides.

5. The orthogonal-mode junction coupler according to claim 1, wherein said converting means includes two or more metal fins symmetrically disposed around said coaxial waveguide and coupled to said sectoral waveguides.

6. The orthogonal-mode junction coupler according to claim 5, wherein said metal fins are tapering in shape extending from said coaxial waveguide toward said sectoral waveguides.

7. The orthogonal-mode junction coupler according to claim 5, wherein said converting means includes four metal fins and the number of sectoral waveguides is four.

8. The orthogonal-mode junction coupler according to claim 7, wherein the number of ridges in said coaxial waveguide and said sectoral waveguides is four.

9. The orthogonal-mode junction coupler according to claim 1, wherein said two or more ridges or T-septa of said coaxial waveguide and said sectoral waveguides are selected from the group consisting of:
two or more ridges symmetrically placed around an inner conductor of said coaxial waveguide and corresponding ridges disposed in broad walls of said sectoral waveguides;
two or more ridges symmetrically placed around an outer conductor of said coaxial waveguide and corresponding ridges disposed in narrow walls of said sectoral waveguides;
two or more double-ridges symmetrically placed in said coaxial waveguide and corresponding double-ridges disposed in said sectoral waveguides;
two or more T-septa symmetrically placed around an inner conductor of said coaxial waveguide and corresponding T-septa disposed in broad walls of said sectoral waveguides;
two or more T-septa symmetrically placed around an outer conductor of said coaxial waveguide and corresponding T-septa disposed in narrow walls of said sectoral waveguides; and
two or more double-T-septa symmetrically placed in said coaxial waveguide and corresponding double-T-septa disposed in said sectoral waveguides.

10. The orthogonal-mode junction coupler according to claim 9, wherein said two or more ridges of said coaxial waveguide are separated by a corresponding number of metal fins symmetrically disposed in said coaxial waveguide as said converting means to separate said ridges or T-septa one from another.

11. The orthogonal-mode junction coupler according to claim 1, wherein a dual-polarised signal input via said coaxial waveguide is separated into said sectoral waveguides.

12. The orthogonal-mode junction coupler according to claim 11, wherein said dual-polarised signal is separated into a higher band signal transmitted by an inner waveguide of said coaxial waveguide and one or more lower band signals transmitted via said sectoral waveguides.

13. The orthogonal-mode junction coupler according to claim 12, wherein a hybrid TE₁₁ mode in said coaxial waveguide is transformed into a hybrid TE₁₀ mode in each of said sectoral waveguides.

14. The orthogonal-mode junction coupler according to claim 13, further including two or more coaxial probes or rectangular waveguides using a T-junction type of structure, wherein said hybrid TE₁₀ mode signals in said sectoral waveguide are coupled to said coaxial probes or rectangular waveguides.

15. The orthogonal-mode junction coupler according to claim 14, further including a coaxial power combiner or a circular orthogonal-mode junction coupler to recombine opposite pairs of said hybrid TE₁₀ mode signals in said coaxial probes or rectangular waveguides to extract said hybrid TE₁₀ mode signals.

16. The orthogonal-mode junction coupler according to claim 13, further including:
a series of coaxial probes in said sectoral waveguides for extracting said hybrid TE₁₀ mode signals; and
a coaxial power combiner for recombining said extracted hybrid TE₁₀ mode signals.

17. The orthogonal-mode junction coupler according to claim 13, further including:
a series of rectangular waveguides on a broad wall of said sectoral waveguides for extracting said hybrid TE₁₀ mode signals; and
a coaxial power combiner or circular orthogonal-mode junction for recombining said extracted hybrid TE₁₀ mode signals.

18. The orthogonal-mode junction coupler according to claim 17, wherein said rectangular waveguides are ridged or have T-septa.

19. The orthogonal-mode junction coupler according to claim 5, having a dual-ridged coaxial structure and two sectional ridged or T-septum waveguides for transforming a single-polarized signal from a coaxial horn into sectional waveguides.

20. The orthogonal-mode junction coupler according to claim 6, wherein said tapering metal fins are used to separate a quad-ridged or quad-T-septum coaxial waveguide into ridged or T-septum sectional waveguides for reducing reflection.
